(19) United States
(12) Patent Application Publication
(10) Pub. No.: US 2022/0128831 A1
(43) Pub. Date: Apr. 28, 2022

(54) RECEIVER MODULE

(71) Applicants: Sintai Optical (Shenzhen) Co., Ltd., ShenZhen City (CN); Asia Optical Co., Inc., Taichung (TW)

(72) Inventors: Yung-Hsiao HUANG, Taichung (TW); Chia-Tse SUN, Taichung (TW)

(21) Appl. No.: 17/487,022

(22) Filed: Sep. 28, 2021

(30) Foreign Application Priority Data
Oct. 27, 2020 (CN) 202011166789.X

(51) Int. Cl. G02B 27/30; G02B 27/09

(52) U.S. Cl. CPC G02B 27/30; G02B 27/0994

(57) ABSTRACT

A receiver module includes an optical fiber configured to transmit a light beam, a collimating lens configured to collimate the light beam, a condensing lens configured to condense the light beam, and a light receiver including a sensor and a lens. The lens is disposed on the sensor, the lens and the sensor are connected to each other, and the sensor includes a light sensing zone. The condensing lens and the light receiver are disposed with respect to each other, and the light beam propagates sequentially through the optical fiber, the collimating lens, the condensing lens and the lens, and is incident on the sensor.

### BACKGROUND OF THE INVENTION

### Field of the Invention

The invention relates to a receiver module, and more particularly to a receiver module for optical communication that is provided with increased assembly tolerance to improve the producing efficiency and the product yield rate.

### Description of the Related Art

Referring to FIG. 1, a conventional receiver module 100 includes a plurality of elements arranged along an optical path, which are sequentially an optical fiber 110, a collimating lens 120, a light splitter 130, a reflecting part disposed in a plastic carrier 140, a condensing lens 150 disposed at the front end of the plastic carrier 140, a light receiver 160 and a circuit board 170.

In operation, light (light signal) from a light emitting end (not shown) propagates through the optical fiber 110, is collimated into parallel light by the collimating lens 120, and reaches the light splitter 130. The light splitter 130 is used for capturing light of specific wavelengths. That is, the light splitter 130 allows the light of specific wavelengths to pass through and filters out the light of other wavelengths (i.e. noises). Then, the light of the specific wavelengths is reflected by the reflecting part which is disposed in the plastic carrier 140, is condensed to the light receiver 160 by the condensing lens 150, and is converted into an electric signal by the light receiver 160 which is disposed on the circuit board 170.

A part of the light may be reflected on the surface of the light receiver 160 and back to the light emitting end along the same optical path. Therefore, the condensing lens 150 is disposed at the front end of the plastic carrier 140 at an inclined angle θ, to reduce the amount of the reflected back light. In the conventional receiver module 100, however, when the plastic carrier 140 is connected to the circuit board 170 by gluing and heating, the raised temperature results in a lateral displacement of the condensing lens 150 with respect to the light receiver 160 because expansion of plastic is more than that of circuit board. Therefore, the assembly tolerance X is required to be less than 5 μm so that the receiver module 100 can normally operate in the temperature range of 0° C.-70° C. However, a 0.5 μm assembly tolerance is a strict requirement that significantly affects the speed of production. Further, the placement of the condensing lens 150 at an inclined angle is also disadvantageous to high-speed product which receives more and more attentions in the present market, thereby limiting the expandability and potential development of the products.

### BRIEF SUMMARY OF THE INVENTION

The invention provides a receiver module to address the described problems. The receiver module in accordance with an exemplary embodiment of the invention includes an optical fiber configured to transmit a light beam, a collimating lens configured to collimate the light beam, a condensing lens configured to condense the light beam, and a light receiver including a sensor and a lens. The lens is disposed on the sensor, the lens and the sensor are connected to each other, and the sensor includes a light sensing zone. The condensing lens and the light receiver are disposed with respect to each other, and the light beam propagates sequentially through the optical fiber, the collimating lens, the condensing lens and the lens, and is incident on the sensor, the condensing lens satisfies: 0.7<F/D_{f}<5.2, where F is a focal length of the condensing lens and D_{f} is a diameter of the condensing lens.

In another exemplary embodiment, the lens is a spherical lens, and a diameter of the light beam is less than ⅓ of that of the spherical lens when the light beam reaches a surface of the spherical lens.

In yet another exemplary embodiment, the receiver module satisfies 5°<θT″<8° where θT″ is a converging angle of the light beam from the condensing lens to the spherical lens.

In another exemplary embodiment, a diameter of the light beam is less than ⅔ of that of the light sensing zone when the light beam reaches the light sensing zone.

In yet another exemplary embodiment, the receiver module satisfies 3.179°<θT<4.763° where θT is a converging angle of the light beam from the lens to the light sensing zone.

In another exemplary embodiment, the condensing lens satisfies 960 μm<F<1543 μm where F is a focal length of the condensing lens.

In yet another exemplary embodiment, the lens is a spherical lens, the condensing lens is configured so that the light beam is vertically incident on the lens, the lens is configured to condense the light beam to the light sensing zone, and the condensing lens satisfies 1 mm≤F≤1.5 mm where F is a focal length of the condensing lens.

In another exemplary embodiment, the condensing lens satisfies 0.075<Tᵣ/D_{f}<0.16 where D_{f} is a diameter of the condensing lens and T_{f} is a thickness of an aspherical zone of the condensing lens.

In yet another exemplary embodiment, the receiver module further includes a light splitter and a reflecting part, the light splitter is used for capturing the light beam of specific wavelengths, the light splitter allows the light beam of specific wavelengths to pass through and filters out the light beam of other wavelengths.

In another exemplary embodiment, wherein the collimating lens, the light splitter, the reflecting part, the condensing lens and the light receiver are sequentially arranged along an optical path followed by the light beam; the collimating lens is configured to collimate the light beam into parallel light; the light splitter is configured to capture a portion of the parallel light that has a specific wavelength; and the reflecting part is configured to reflect the portion of the parallel light to the condensing lens.

The invention provides another receiver module to address the described problems. The receiver module in accordance with an exemplary embodiment of the invention includes an optical fiber configured to transmit a light beam, a collimating lens configured to collimate the light beam, a condensing lens configured to condense the light beam, and a light receiver including a sensor and a lens. The lens is disposed on the sensor, the lens and the sensor are connected to each other, and the sensor includes a light sensing zone. The condensing lens and the light receiver are disposed with respect to each other, and the light beam propagates sequentially through the optical fiber, the collimating lens, the condensing lens and the lens, and is incident on the sensor, the condensing lens satisfies: 1 mm≤F≤1.5 mm, where F is a focal length of the condensing lens.

The invention provides another receiver module to address the described problems. The receiver module in accordance with an exemplary embodiment of the invention includes an optical fiber configured to transmit a light beam, a collimating lens configured to collimate the light beam, a condensing lens configured to condense the light beam, and a light receiver including a sensor and a lens. The lens is disposed on the sensor, the lens and the sensor are connected to each other, and the sensor includes a light sensing zone. The condensing lens and the light receiver are disposed with respect to each other, and the light beam propagates sequentially through the optical fiber, the collimating lens, the condensing lens and the lens, and is incident on the sensor, the condensing lens satisfies: 0.075<T_{f}/D_{f}<0.16, where D_{f} is a diameter of the condensing lens and T_{f} is a thickness of an aspherical zone of the condensing lens.

In another exemplary embodiment, the condensing lens at least one of the following conditions: 8.179°<θT″+θT<12.763°; 1.5<θT″/θT<1.7; 4<F/T_{f}<69; where θT″ is a converging angle of the light beam from the condensing lens to the lens and θT is a converging angle of the light beam from the lens to the light sensing zone, F is a focal length of the condensing lens, and T_{f} is a thickness of an aspherical zone of the condensing lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram showing of a conventional receiver module;

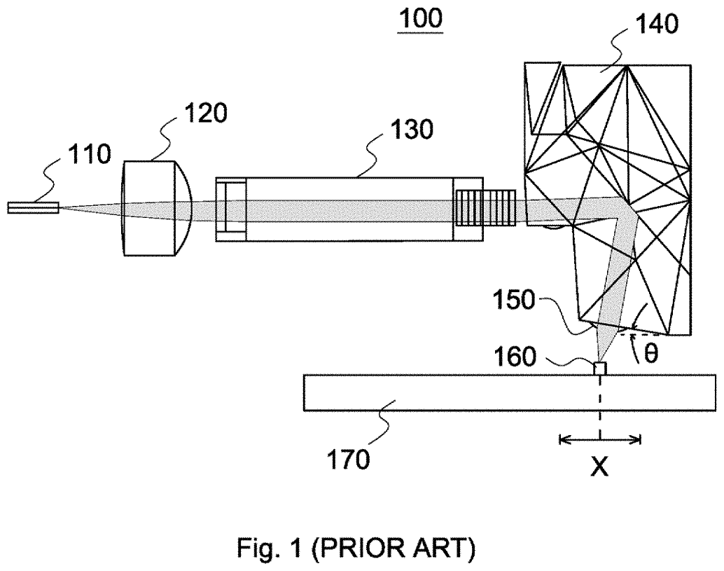

FIG. 2 is a schematic diagram showing of a receiver module of the invention;

FIG. 3 is an enlarged view of portion III of FIG. 2;

FIG. 4 is an enlarged view of the light receiver of the receiver module of the invention; and

FIG. 5 is an enlarged view of the light sensing zone of the receiver module of the invention.

### DETAILED DESCRIPTION OF THE INVENTION

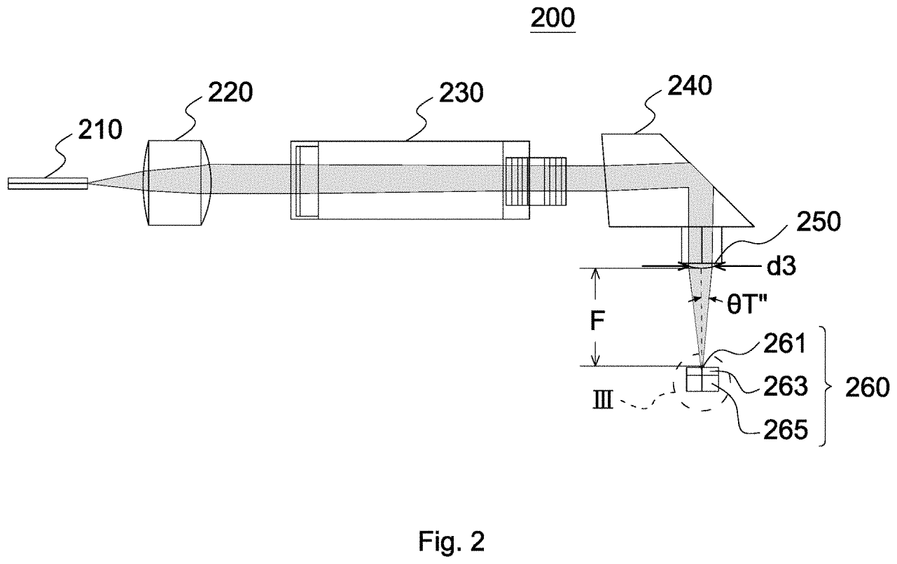

Referring to FIG. 2, a receiver module 200 of the invention includes a plurality of elements arranged along an optical path, which are sequentially an optical fiber 210, a collimating lens 220, a light splitter 230, a reflecting part disposed in a plastic carrier 240, a condensing lens 250 disposed at the front end of the plastic carrier 240, and a light receiver 260.

In operation, a light beam (i.e. light signal) from a light emitting end (not shown) propagates through the optical fiber 210, is collimated into parallel light by the collimating lens 220, and reaches the light splitter 230. The light splitter 230 is used for processing the light beam (e.g. capturing light of specific wavelengths). Then, the light of the specific wavelengths is reflected by the reflecting part (disposed in the plastic carrier 240) to change the propagating direction, and is condensed to the light receiver 260 by the condensing lens 250.

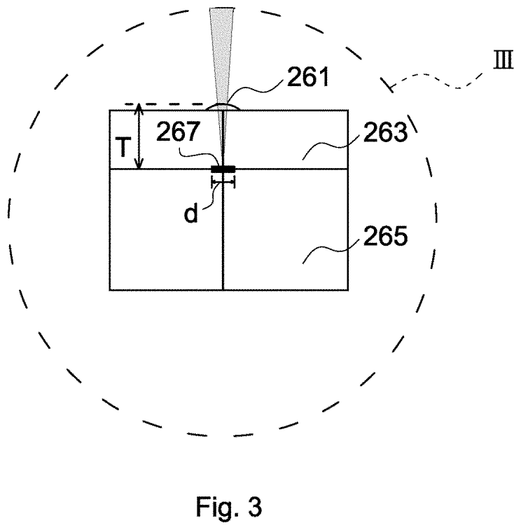

Referring to FIGS. 2 and 3, the light receiver 260 includes a carrier 265, a sensor 263 and a lens 261. The carrier 265 is configured to carry the sensor 263. The sensor 263 includes a light sensing zone 267. The lens 261 is disposed on the sensor 263 for condensing the light that comes from the condensing lens 250 to the light sensing zone 267 of the sensor 263. The lens 261 and the sensor 263 are connected to each other by, for example, tightly contacting, gluing, adhering, engaging or the like, so that no air gap is formed therebetween. Accordingly, the light beam (light signal) propagates through the optical fiber 210, the collimating lens 220, the light splitter 230, the reflecting part disposed in the plastic carrier 240, the condensing lens 250, and the lens 261 of the light receiver 260 to the sensor 263.

It is understood from the above descriptions that the light beam is condensed twice before reaching the light sensing zone 267, wherein condensing the light beam to the surface of the lens 261 by the condensing lens 250 is the first time the light beam is condensed, and condensing the light beam to the light sensing zone 267 by the lens 261 is the second time the light beam is condensed. By such arrangement, the dimension of light spot onto the lens 261 can be well controlled and the assembly tolerance can be increased to greater than 20 μm. Thus, the assembly tolerance, producing efficiency and product yield rate are all improved.

It is worth noting that the invention modifies the placement of the condensing lens. The condensing lens 150 of the conventional receiver module 100 is placed at an inclined angle, while the condensing lens 250 of the invention is horizontally placed so that the light beam can be vertically incident on the light receiver 260. Further, the invention increases the distance between the condensing lens 250 and the lens 261 (i.e. the focal length F of the condensing lens 250) to avoid an excessive amount of light reflected from the light receiver 260 back to the light emitting end. Further, the focal length F is properly adjusted so that the light beam can be converged to a small range, thereby increasing the assembly tolerance up to 20 μm, facilitating the assembly of the receiver module, and improving the producing efficiency and the product yield rate. Therefore, the receiver module of the invention is reliable and the function thereof can be maintained.

In this embodiment, the lens 261 is a spherical lens. Because a sufficient space (i.e. the described ±20 μm) for adjusting the receiver module 200 during the optical coupling process is required, the diameter of the light beam is necessarily converged to less than ⅓ of the diameter of the lens 261 when the light beam reaches the surface of the lens 261. That is, the diameter of the light beam on the surface of the lens 261 is less than ⅓ of the diameter of the lens 261. To achieve this, a converging angle θT″ from the condensing lens 250 to the lens 261 satisfies the following condition:

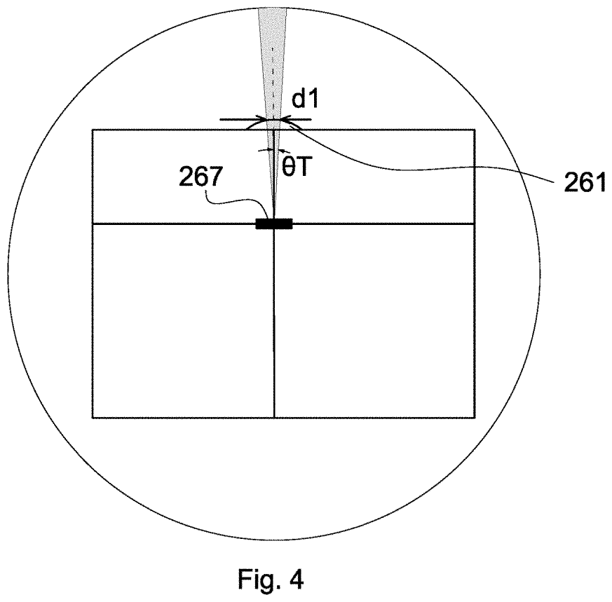

5°<θT″<8° (1)

wherein the converging angle θT″=tan⁻¹ ((d3−d1)/2F),

where d3 is the diameter of the light beam on the surface of the condensing lens 250 (FIG. 2), d1 is the diameter of the light beam on the surface of the lens 261 (FIG. 4), and F is the focal length of the condensing lens 250 (FIG. 2).

If the light beam is not vertically incident onto the light receiver 260 because of the assembly tolerance or other factors, then introduction of some other non-vertical light beams to focus on the light sensing zone 267 will be required (for the purpose that the receiver module 200 can normally operate). To achieve this, the diameter of the light beam is necessarily converged to less than ⅓ of the diameter of the light sensing zone 267 when the light beam reaches the light sensing zone 267. That is, the diameter of the light beam on the surface of the light sensing zone 267 is less than ⅔ of the diameter d of the light sensing zone 267. Accordingly, a converging angle θT from the lens 261 to the light sensing zone 267 satisfies the following condition:

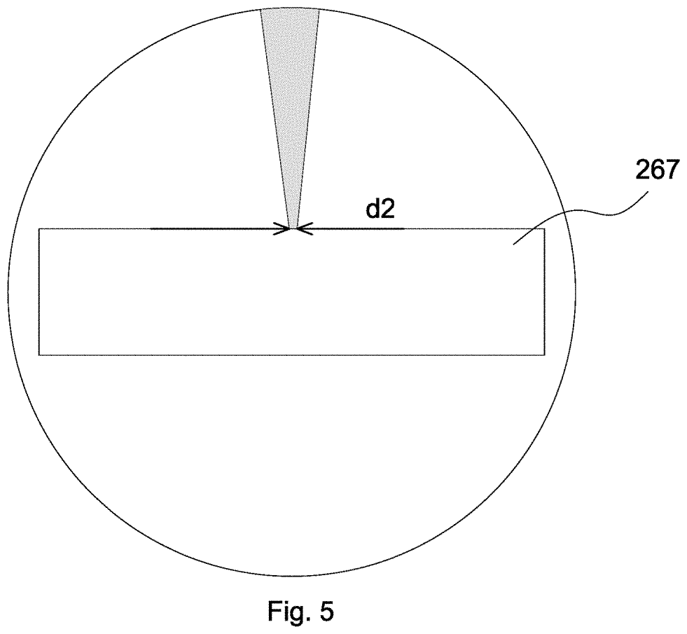

3.179°<θT<4.763° (2)

wherein the converging angle θT=tan⁻¹ ((d2−d1)/2T),

where d2 is the diameter of the light beam on the surface of the light sensing zone 267 (FIG. 5), d1 is the diameter of the light beam on the surface of the lens 261 (FIG. 4), and T is the distance between the vertex of the lens 261 and the bottom surface of the sensor 263 (FIG. 3).

In this embodiment, T=120 μm-180 μm where T is the distance from the vertex of the lens 261 to the bottom surface of the sensor 263; d3≈300 μm where d3 is the diameter of the light beam on the condensing lens 250; d1≤30 μm where d1 is the diameter of the light beam on the lens 261; and d2≤10 μm where d2 is the diameter of the light beam in the light sensing zone 267. When the above conditions (1) and (2) are required, the focal length F of the condensing lens 250 of the invention is greater than 960 μm and less than 1543 μm, i.e. 960 μm<F<1543 μm. Preferably, 1 mm≤F≤1.5 mm.

To satisfy the above conditions of the focal length F of the condensing lens 250, it is required that the focal length F, the diameter D_{f} and the thickness T_{f} of the aspherical zone of the condensing lens 250 have a predetermined proportional relations therebetween. Specifically, the diameter D_{f} of the condensing lens 250 is the maximum outer diameter of the condensing lens 250 and 0.3 mm<D_{f}<1.3 mm. The thickness T_{f} of the aspherical zone of the condensing lens 250 is the central thickness of the condensing lens 250, namely the distance between the intersections of the lens and the optical axis, and 0.0225 mm<T_{f}<0.208 mm. For example, when 960 μm<F<1543 μm, the following conditions are necessarily satisfied:

0.075<T_{f}/D_{f}<0.16 (3)

0.7<F/D_{f}<5.2 (4)

8.179°<θT″+θT<12.763° (5)

1.5<θT″/θT<1.7 (6)

4<F/T_{f}<69 (7)

Condition (5) is a combination of the condition (1) and condition (2), specifically, the condition (5) is obtained from the condition (1) plus condition (2). Condition (6) is a combination of the condition (1) and condition (2), specifically, the condition (6) is obtained from the condition (1) divided by condition (2). Condition (7) is a combination of the condition (3) and condition (4), specifically, the condition (7) is obtained from the condition (4) divided by condition (3). By such arrangement that the receiver module of the invention satisfies the conditions (1)-(7), the dimension of light spot onto the lens 261 can be well controlled and the assembly tolerance can be increased to greater than 20 μm. Thus, the assembly tolerance, producing efficiency and product yield rate are all improved. Therefore, the receiver module of the invention is reliable and the function thereof can be maintained.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A receiver module, comprising:
an optical fiber configured to transmit a light beam;
a collimating lens configured to collimate the light beam;
a condensing lens configured to condense the light beam;
a light receiver comprising a sensor and a lens, wherein the lens is disposed on the sensor, the lens and the sensor are connected to each other, and the sensor comprises a light sensing zone;
wherein the condensing lens and the light receiver are disposed with respect to each other, and the light beam propagates sequentially through the optical fiber, the collimating lens, the condensing lens and the lens, and is incident on the sensor;
wherein the condensing lens satisfies: 0.7<F/D_{f}<5.2, where F is a focal length of the condensing lens and D_{f} is a diameter of the condensing lens.

2. The receiver module as claimed in claim 1, wherein the lens is a spherical lens, and a diameter of the light beam is less than ⅓ of that of the spherical lens when the light beam reaches a surface of the spherical lens.

3. The receiver module as claimed in claim 2, wherein the receiver module satisfies:
5°<θT″<8°
where θT″ is a converging angle of the light beam from the condensing lens to the spherical lens.

4. The receiver module as claimed in claim 1, wherein a diameter of the light beam is less than ⅔ of that of the light sensing zone when the light beam reaches the light sensing zone.

5. The receiver module as claimed in claim 4, wherein the receiver module satisfies:
3.179°<θT<4.763°
where θT is a converging angle of the light beam from the lens to the light sensing zone.

6. The receiver module as claimed in claim 1, wherein the condensing lens satisfies:
960 μm<F<1543 μm
where F is a focal length of the condensing lens.

7. The receiver module as claimed in claim 1, wherein the lens is a spherical lens, the condensing lens is configured so that the light beam is vertically incident on the lens, the lens is configured to condense the light beam to the light sensing zone.

8. The receiver module as claimed in claim 7, wherein the condensing lens satisfies:
1 mm≤F≤1.5 mm
where F is the focal length of the condensing lens.

9. The receiver module as claimed in claim 1, wherein the condensing lens satisfies:
0.075<T_{f}/D_{f}<0.16
where D_{f} is a diameter of the condensing lens and T_{f} is a thickness of an aspherical zone of the condensing lens.

10. The receiver module as claimed in claim 1, further comprising a light splitter and a reflecting part, wherein the light splitter is used for capturing the light beam of specific wavelengths, and the light splitter allows the light beam of specific wavelengths to pass through and filters out the light beam of other wavelengths.

11. The receiver module as claimed in claim 10, wherein the collimating lens, the light splitter, the reflecting part, the condensing lens and the light receiver are sequentially arranged along an optical path followed by the light beam.

12. The receiver module as claimed in claim 11, wherein the collimating lens is configured to collimate the light beam into parallel light, the light splitter is configured to capture a portion of the parallel light that has a specific wavelength, and the reflecting part is configured to reflect the portion of the parallel light to the condensing lens.

13. A receiver module, comprising.
an optical fiber configured to transmit a light beam;
a collimating lens configured to collimate the light beam;
a condensing lens configured to condense the light beam;
a light receiver comprising a sensor and a lens, wherein the lens is disposed on the sensor, the lens and the sensor are connected to each other, and the sensor comprises a light sensing zone;
wherein the condensing lens and the light receiver are disposed with respect to each other, and the light beam propagates sequentially through the optical fiber, the collimating lens, the condensing lens and the lens, and is incident on the sensor;
wherein the condensing lens satisfies: 1 mm≤F≤1.5 mm, where F is a focal length of the condensing lens.

14. The receiver module as claimed in claim 13, wherein the lens is a spherical lens, wherein the receiver module satisfies at least one of the following conditions:
5°<θT″<8°;
3.179°<θT<4.763°;
where θT″ is a converging angle of the light beam from the condensing lens to the spherical lens and θT is a converging angle of the light beam from the lens to the light sensing zone.

15. The receiver module as claimed in claim 13, wherein the lens is a spherical lens, the receiver module satisfies at least one of the following conditions:
8.179°<θT″+θT<12.763°;
1.5<θT″/θT<1.7;
where θT″ is a converging angle of the light beam from the condensing lens to the spherical lens and θT is a converging angle of the light beam from the lens to the light sensing zone.

16. The receiver module as claimed in claim 13, wherein the condensing lens satisfies at least one of the following conditions:
0.075<T_{f}/D_{f}<0.16;
0.7<F/D_{f}<5.2;
4<F/T_{f}<69;
where D_{f} is a diameter of the condensing lens, T_{f} is a thickness of an aspherical zone of the condensing lens, and F is a focal length of the condensing lens.

17. A receiver module, comprising.
an optical fiber configured to transmit a light beam;
a collimating lens configured to collimate the light beam;
a condensing lens configured to condense the light beam;
a light receiver comprising a sensor and a lens, wherein the lens is disposed on the sensor, the lens and the sensor are connected to each other, and the sensor comprises a light sensing zone;
wherein the condensing lens and the light receiver are disposed with respect to each other, and the light beam propagates sequentially through the optical fiber, the collimating lens, the condensing lens and the lens, and is incident on the sensor;
wherein the condensing lens satisfies: 0.075<T_{f}/D_{f}<0.16, where D_{f} is a diameter of the condensing lens and T_{f} is a thickness of an aspherical zone of the condensing lens.

18. The receiver module as claimed in claim 17, further comprising a light splitter and a reflecting part, wherein the light splitter is used for capturing the light beam of specific wavelengths, and the light splitter allows the light beam of specific wavelengths to pass through and filters out the light beam of other wavelengths;
wherein the collimating lens, the light splitter, the reflecting part, the condensing lens and the light receiver are sequentially arranged along an optical path followed by the light beam; the collimating lens is configured to collimate the light beam into parallel light; the light splitter is configured to capture a portion of the parallel light that has a specific wavelength; and the reflecting part is configured to reflect the portion of the parallel light to the condensing lens.

19. The receiver module as claimed in claim 17, wherein the condensing lens satisfies at least one of the following conditions:
960 μm<F<1543 μm;
0.7<F/D_{f}<5.2;
where D_{f} is a diameter of the condensing lens and F is a focal length of the condensing lens.

20. The receiver module as claimed in claim 17, wherein the receiver module satisfies at least one of the following conditions:
8.179°<θT″+θT<12.763°;
1.5<θT″/θT<1.7;
4<F/T_{f}<69;
where θT″ is a converging angle of the light beam from the condensing lens to the lens, θT is a converging angle of the light beam from the lens to the light sensing zone, F is a focal length of the condensing lens, and T_{f} is the thickness of an aspherical zone of the condensing lens.
